(19) United States
(12) Patent Application Publication
(10) Pub. No.: US 2011/0011872 A1
(43) Pub. Date: Jan. 20, 2011

(54) Egg baker

(76) Inventor: Julia A. Fulton-Morales, Corpus Christi, TX (US)

Correspondence Address: Julia A. Fulton-Morales, 5302 Wentworth Drive, Corpus Christi, TX, 78413, US

(21) Appl. No.: 12/460,242

(22) Filed: Jul. 16, 2009

(51) Int. Cl. A47J 37/01

(52) U.S. Cl. 220/573.1

(57) ABSTRACT

A new way of preparing eggs. Users of the product may find this new technique to be of better taste, easier to use and clean, and healthier then traditional egg cooking techniques.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Earthenware—For class 425

A product made of (1) slightly porous opaque clay fired at low heat; (2) inorganic settable ingredient containing, hand-crafted clay pottery (3) powdered metal (4) ceramics other than glass or slag; (5) alkali metal silicate containing.

### BRIEF SUMMARY OF THE INVENTION

### Figures of Earthenware for Egg Baking Purpose

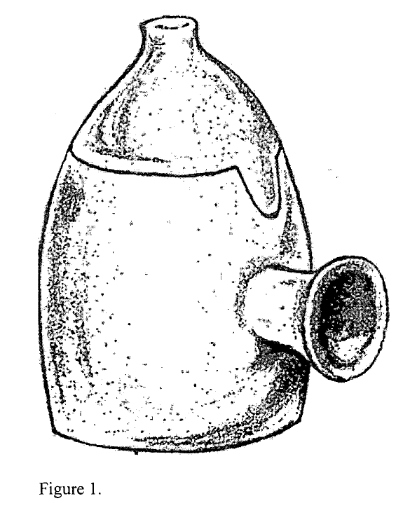

### BRIEF DESCRIPTION OF THE DRAWING (FIG. 1)

“The dish is 5½ inches in height has a unique shank style handle with a wide end the widest point (handle included) is 5 inches wide the opening where the lid lies is 2½ inches wide the lid itself has a unique tongue the tongue starts at 20 degrees then the rest of the lid is 340 degrees with a knob shape point on top of lid. See attached drawing 1. Drawing 2 shows the registered trade name to be used for advertising and other purposes.

### DETAILED DESCRIPTION OF THE INVENTION

The Egg Baker is figures of earthenware for egg baking purposes. Clay pottery cooking has been around for hundreds of years. The Egg Baker is a new invention that is hand-crafted porous, earthen product design for baking eggs in its own juices and natural flavors. The Egg Baker is a versatile invention that can be used in stove top, oven, microwave and other home cooking appliances. Many recipes can be baked in the Egg Baker. These recipes include huevos panaderos, egg baker A'la Suisse, the westerner and the Sunday brunch baker.

The totally glazed Egg Baker does not absorb moisture or food flavor. This allows the egg to fully bake in its own moisture and flavors. The result is a tender, flavorful dish. Because, no oil needs to be added with this cooking technique, eggs baked in the Egg Baker may be lower in fat compared with food prepared by other methods. In addition, nutrients are retained in the egg resulting in a healthier egg with better flavor. the handle of the Egg Baker does not get hot. In fact, the entire design of the Egg baker allows for convenient and easy handling of the product. The user of the Egg Baker has ability to add spices or other items to satisfy the taste of the consumer.

The inventor of the Egg Baker makes one claim stated as follows:

1. The invention of a product made of glazed clay and shaped in a certain way for the specific purpose of baking eggs.
